(19) United States
(12) Patent Application Publication
(10) Pub. No.: US 2005/0100685 A1
(43) Pub. Date: May 12, 2005

(54) Process for the production of a clear top coat layer on automotive bodies

(76) Inventors: Carmen Flosbach, Wuppertal (DE); Jennifer Donnermeyer, Mainburg (DE); Thomas Tuerk, Landshut (DE); Kamelia Detig-Karlou, Pullach (DE); Gerhard Steurer, Roehrmoos (DE); Marco Kohls, Muenchen (DE)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/962,733

(22) Filed: Oct. 12, 2004

(30) Foreign Application Priority Data
Nov. 11, 2003 (DE) DE 103 52 447.9

(51) Int. Cl. B05D 3/12; B32B 27/00

(52) U.S. Cl. 428/31; 427/558; 427/421.1; 428/500

(57) ABSTRACT

A process for the production of a clear top coat layer on automotive bodies comprises the following steps: a) spray application onto at least portions of the precoated surface of the automotive bodies, that are not directly accessible to an external observer but are in principle accessible to spray coating, of a clear coat layer from a clear coating composition A curable by free-radical polymerization of olefinic double bonds on exposure to UV radiation, b) spray application onto the outer surface, finished in color-determining manner, of the automotive bodies, which surface is directly accessible to an external observer and to spray coating, of a clear coat layer from a clear coating composition B curable by free-radical polymerization of olefinic double bonds on exposure to UV radiation, and c) curing of the clear coat layers by UV radiation-induced, free-radical polymerization of olefinic double bonds, wherein the clear coating compositions A and B, differ from one another (1) by having a higher content of photoinitiator(s) or (2) by having a lower content of light stabilizer(s) and/or UV absorber(s) or (3) by having a lower content of light stabilizer(s) and/or UV absorber(s) with compositions A and B having a different content of photoinitiator(s).

### CROSS REFERENCE TO RELATED APPLICATIONS

This application claims the benefit of priority from German Patent Application DE 103 52 447.9 filed on Nov. 11, 2003, incorporated by reference herein in its entirety.

### FIELD OF THE INVENTION

The invention relates to a process for the production of a clear top coat layer on automotive bodies using clear coating compositions curable by free-radical polymerization of olefinic double bonds on exposure to UV radiation.

### BACKGROUND OF THE INVENTION

The production of a clear top coat layer on automotive bodies, which have been provided with a base coat layer, using a clear coating composition curable by free-radical polymerization of olefinic double bonds on exposure to UV radiation (ultraviolet radiation) is known from EP 0 540 884 A1. To address the problem of curing portions of the clear coat film located in shaded zones (portions of the surface which are inaccessible to direct irradiation with UV light), EP 0 540 884 A1 proposes using punctual, small area or omnidirectional radiation sources in conjunction with an automatic motion apparatus in order to permit UV irradiation of interior or engine compartments, cavities or edges.

Another solution involves using so-called dual-cure clear coats known to the person skilled in the art which contain binder systems containing not only components curable by free-radical polymerization of olefinic double bonds on exposure to UV radiation but also thermally curable components. Clear coat films applied from dual-cure clear coats are cured by exposure to UV radiation and by supply of thermal energy. Zones of the clear coating located in shaded zones are accordingly subjected to at least the thermal part of curing. To this extent, a usable surface is obtained in shaded zones, even if the part of curing due to the free-radical polymerization of olefinic double bonds does not proceed or proceeds only inadequately due to inadequate UV light access.

It would be desirable to provide a process for the production of a clear top coat layer on automotive bodies using a clear coat curable by free-radical polymerization of olefinic double bonds on exposure to UV radiation without having to provide special equipment for purposefully irradiating the shaded zones with UV light. In other words, the process to be provided should ensure that a clear top coat layer of a clear coating composition curable by free-radical polymerization of olefinic double bonds on exposure to UV radiation which has been applied onto automotive bodies is in each case adequately cured by UV radiation-induced free-radical polymerization of olefinic double bonds both on the outer body skin and in shaded zones of the automotive bodies without having to use complex equipment to carry out purposeful UV irradiation of shaded zones.

Surprisingly, this object is achieved by using two clear coating compositions curable by free-radical polymerization of olefinic double bonds on exposure to UV radiation, which coating compositions differ with regard to content of photoinitiator and/or light stabilizer or UV absorber, when applying the clear top coat layer onto automotive bodies.

### SUMMARY OF THE INVENTION

The present invention accordingly provides a process for the production of a clear top coat layer on automotive bodies, characterized in that application of the clear coat comprises the following steps:
a) spray application onto at least portions of the precoated surface of the automotive bodies, which portions are not directly accessible to an external observer but are in principle accessible to spray coating, of a clear coat layer from a clear coating composition A curable by free-radical polymerization of olefinic double bonds on exposure to UV radiation,
b) spray application onto the outer surface, finished in color-determining manner, of the automotive bodies, which surface is directly accessible to an external observer and to spray coating, of a clear coat layer from a clear coating composition B curable by free-radical polymerization of olefinic double bonds on exposure to UV radiation, and
c) curing of the clear coat layer applied from clear coating compositions A and B in process steps a) and b) by means of UV radiation-induced, free-radical polymerization of olefinic double bonds,
wherein the clear coating compositions A and B, in each case relative to the resin solids content thereof, differ from one another (1) by clear coating composition A having a higher content of photoinitiator(s) or (2) by clear coating composition A having a lower content of light stabilizer(s) and/or UV absorber(s) or (3) by clear coating composition A having a lower content of light stabilizer(s) and/or UV absorber(s) with clear coating compositions A and B at the same time having a different content of photoinitiator(s).

### DETAILED DESCRIPTION OF THE INVENTION

In the process according to the invention, a distinction is drawn between the outer surface of automotive bodies which is directly accessible to an external-observer and to spray coating and the surface of automotive bodies which is not directly accessible to an external observer but is in principle accessible to spray coating.

The outer surface of an automotive body which is directly accessible to an external observer and to spray coating comprises the outer body skin, including any externally visible plastics body parts, which is immediately visible with the doors, bonnet and boot lid closed.

The surface of automotive bodies which is not directly accessible to an external observer but is in principle accessible to spray coating comprises all internal surfaces of the body which, with the bonnet, doors and boot lid closed, are not accessible to an external observer but, once the bonnet, doors and boot lid have been opened, are in principle accessible to spray coating. Examples include all the surfaces belonging to door entries (surface of the frame-like door opening in the body; internal surfaces of the door, i.e. door frame and inner side of door), surfaces of the boot and engine compartment, inner sides of boot lid and bonnet, all visible surfaces of the passenger compartment, but not the underbody and concealed surfaces which are fundamentally inaccessible to spray coating, such as surfaces behind undercuts or internal surfaces of cavities.

In the process according to the invention, automotive bodies which are ready for application of a clear top coat layer, said bodies possibly also including, in addition to the actual precoated metal body, plastics parts precoated in color-determining manner and/or plastics parts through-colored in color-determining manner, are provided with a clear top coat layer. The precoating comprises coating layers or coating layer structures conventional for automotive bodies and any body parts made from non-through-colored plastics which merely lack a final clear top coat layer.

Examples of coating layers or coating layer structures without a final clear top coat layer conventional for automotive bodies are a conventional electrodeposition coating primer, a coating structure comprising a conventional electrodeposition coating primer and conventional filler coat and a coating structure which determines the body color comprising a conventional electrodeposition coating primer and a predried or completely dried, for example baked, base coat layer of a conventional color- and/or special effect-imparting solvent-based base coat or preferably water-borne base coat. The coating structure comprising electrodeposition coating primer and base coat layer may comprise interlayers arranged therebetween. Examples of such interlayers are conventional filler layers or a base coat layer modified by conventional additions, as are for example known from WO 94/21730, WO 96/12769, WO 97/30795 or WO 97/47401.

Examples of color-determining precoatings conventional on body parts made from non-through-colored plastics are a predried or completely dried, for example baked, base coat layer of a conventional color- and/or special effect-imparting solvent-based base coat or preferably of a water-borne base coat, which base coat layer may include one or more coating layers, for example a conventional plastics primer layer, arranged thereunder.

The precoating on the metal body surface may be everywhere identical and so color-determining or differ in different zones of the surface and so optionally not everywhere be color-determining. While the entire metal body surface is provided with an electrodeposition coating primer, a base coat layer determining the body color or a corresponding color-determining coating structure may, for example, be applied only onto visually obvious zones of the body surface, for example in order to save paint. Examples of such visually obvious surface zones are areas visible to the customer on the finished motor vehicle, namely, apart from the outer body skin, the door entries and any areas not covered with trim in the interior of the finished motor vehicle. Less visually significant zones of the body surface, such as for example in the boot, on the inner side of the boot lid, in the engine compartment, on the inner side of the bonnet and on trim-covered areas in the interior of the finished motor vehicle, may be coated, in addition to the electrodeposition coating primer, with an interlayer and base coat, or only with interlayer or only with base coat or they comprise no further coating layer other than the electrodeposition coating primer.

In each case, the precoating comprises, in addition to the electrodeposition coating primer of the entire metal body surface, a color-determining base coat layer on the outer body skin and on the surfaces belonging to the door entries, at least to that extent that the surfaces belonging to the door entries are not covered with trim on the finished motor vehicle. In general, one or more interlayers are arranged between the base coat layer and the electrodeposition coating. Any body parts made from non-through-colored plastics are precoated on the surface facing towards an external observer with a color-determining base coat and optionally one or more coating layers arranged thereunder.

In process steps a) and b) of the process according to the invention, clear coating compositions A and B curable by free-radical polymerization of olefinic double bonds on exposure to UV radiation are applied by spraying.

Clear coating compositions A and B may comprise liquid, solvent- and/or water-containing or solvent- and water-free clear coating compositions or powder clear coating compositions, which in each case comprise a resin solids content composed of the binders contained in the clear coating compositions together with any optionally present reactive diluents and optionally present crosslinking agents, preferably composed solely of binder(s) with free-radically polymerizable olefinic double bonds and optionally reactive diluents. The aqueous clear coating compositions may comprise solutions or dispersion systems in the form of emulsions or suspensions. Clear coating compositions A and B are preferably identical in nature, for example in each case being solvent-based, aqueous or powder coating systems. In particular, clear coating compositions A and B preferably in each case comprise powder clear coatings.

The clear coating compositions A and B contain one or more binders with free-radically polymerizable olefinic double bonds. Suitable binders with free-radically polymerizable olefinic double bonds which may be considered are, for example, any binders known to the skilled person which can be crosslinked by free-radical polymerization. These binders are prepolymers such as polymers and oligomers containing, per molecule, one or more, preferably on average 2 to 20, particularly preferably 3 to 10 free-radically polymerizable olefinic double bonds. The polymerizable double bonds may, for example, be present in the form of (meth)acryloyl, vinyl, allyl, maleate and/or fumarate groups. The free-radically polymerizable double bonds are particularly preferably present in the form of (meth)acryloyl groups.

Both here and below, (meth)acryloyl or (meth)acrylic are intended to mean acryloyl and/or methacryloyl or acrylic and/or methacrylic.

Examples of prepolymers include (meth)acryloyl-functional (meth)acrylic copolymers, polyurethane (meth)acrylates, polyester (meth)acrylates, unsaturated polyesters, polyether (meth)acrylates, silicone (meth)acrylates, epoxy (meth)acrylates, amino (meth)acrylates and melamine (meth)acrylates. The number average molar mass Mn of these compounds may, for example, be from 500 to 10,000 g/mol, preferably from 500 to 5000 g/mol. The binders may be used individually or as a mixture. (Meth)acryloyl-functional (meth)acrylic copolymers and/or polyurethane (meth)acrylates are preferably used.

The prepolymers may be used in combination with reactive diluents, i.e. free-radically polymerizable low molecular weight compounds with a molar mass of below 500 g/mol. The reactive diluents may be mono-, di- or polyunsaturated. Examples of monounsaturated reactive diluents are (meth)acrylic acid and the esters thereof, maleic acid and the semi-esters thereof, vinyl acetate, vinyl ethers, substituted vinyl ureas, styrene, vinyltoluene. Examples of diunsaturated reactive diluents are di(meth)acrylates, such as polyethylene glycol di(meth)acrylate, 1,3-butanediol di(meth)acrylate, vinyl (meth)acrylate, allyl (meth)acrylate, divinylbenzene, dipropylene glycol di(meth)acrylate, hexanediol di(meth)acrylate. Examples of polyunsaturated reactive diluents are glycerol tri(meth)acrylate, trimethylolpropane tri(meth)acrylate, pentaerythritol tri- and tetra(meth)acrylate. The reactive diluents may be used alone or in mixture.

It may be expedient if the binders with free-radically polymerizable olefinic double bonds present in clear coating composition A have a higher glass transition temperature than the binders with free-radically polymerizable olefinic double bonds present in clear coating composition B.

It may likewise be expedient if the binders with free-radically polymerizable olefinic double bonds present in clear coating composition A exhibit greater reactivity with regard to free-radical polymerization than the binders with free-radically polymerizable olefinic double bonds present in clear coating composition B, for example due to the binders with free-radically polymerizable olefinic double bonds of the clear coating composition A having a higher content of free-radically polymerizable olefinic double bonds.

In addition to the free-radically polymerizable binder components or in addition to the free-radically polymerizable functional groups, clear coating compositions A and B may also, although not preferably, contain further binder and optionally crosslinking components or further functional groups which are chemically crosslinkable by an additional, thermal curing mechanism, for example by condensation and/or addition reactions. In this case, clear coating compositions A and B are dual-cure clear coats. Further chemically crosslinkable binders which may preferably be used are single component binder systems, for example based on OH-functional compounds, amino resins and/or blocked polyisocyanates or those based on carboxy-functional and epoxy-functional compounds. Moisture-curing binder components are also possible, for example compounds with free isocyanate groups, with hydrolyzable alkoxysilane groups or with amino groups blocked as ketimine or aldimine groups. The additional functional groups and the free-radically polymerizable functional groups may be present in the same binder and/or in separate binders.

Clear coating compositions A and B contain one or more photoinitiators, for example in (total) quantities of 0.1 to 5 wt. %, preferably of 0.5 to 3 wt. %, relative to the resin solids content of the particular clear coating composition. Examples of photoinitiators are benzoin and derivatives thereof, acetophenone and derivatives thereof, for example 2,2-diacetoxyacetophenone, benzophenone and derivatives thereof, thioxanthone and derivatives thereof, anthraquinone, 1-benzoylcyclohexanol, organophosphorus compounds such as for example acylphosphine oxides. The photoinitiators may be used individually or in combination. Clear coating compositions A and B preferably contain the same photoinitiator(s).

The clear coating composition B and optionally also the clear coating composition A contain one or more light stabilizers and/or UV absorbers, for example in (total) quantities of 0.1 to 5 wt. %, preferably of 0.5 to 3 wt. %, relative to the resin solids content of the particular clear coating composition. Examples of light stabilizers are the conventional HALS light stabilizers (HALS, hindered amine light stabilizer) known to the person skilled in the art based on sterically hindered amines, in particular corresponding piperidine derivatives or also sterically hindered morpholine-2-one derivatives, in particular morpholin-2-one derivatives sterically hindered by 3,3,5,5-polysubstitution. Examples of UV absorbers are the conventional oxalanilides, benzotriazoles and benzotriazines known to the person skilled in the art. If the clear coating compositions A contain light stabilizers and/or UV absorbers, they preferably contain the same light stabilizers and/or UV absorbers as the clear coating compositions B.

Clear coating compositions A and B differ, in each case relative to the resin solids content thereof, (1) by clear coating composition A having a higher content of photoinitiator(s) or (2) by clear coating composition A having a lower content of light stabilizer(s) and/or UV absorber(s) or (3) by clear coating composition A having a lower content of light stabilizer(s) and/or UV absorber(s) with clear coating composition A simultaneously having a different, i.e. higher or lower, content of photoinitiator(s). In comparison with clear coating composition B, clear coating composition A thus contains (1) more, for example 10 to 500% more photoinitiator(s) (example calculation: clear coating composition B contains 1 wt. % photoinitiator, relative to resin solids content, clear coating composition A contains 2 wt. % photoinitiator, relative to resin solids content; clear coating composition A accordingly contains 100% more photoinitiator than clear coating composition B) or (2) no or less, for example 10 to 100% less light stabilizer(s) and/or UV absorber(s) or (3a) simultaneously less photoinitiator(s) and no or less light stabilizer(s) and/or UV absorber(s) or (3b) simultaneously more photoinitiator(s) and no or less light stabilizer(s) and/or UV absorber(s). Clear coating composition A preferably contains no or less light stabilizer(s) and/or UV absorber(s) than clear coating composition B, wherein it is possible for the content of photoinitiator(s) to be equally high, higher or lower than in clear coating composition B. Especially if the clear coating composition A contains no or only very little UV absorber, particularly small proportions of photoinitiator may optionally be used in the clear coating composition A, in particular those photoinitiators which respond in the UV-A or UV-B wavelength range.

In one particularly preferred embodiment of the process according to the invention, the clear coating compositions A and B differ only by their differing content(s) of photoinitiator(s), light stabilizer(s) or UV absorber(s), i.e. not with regard to the other constituents thereof. In particular, it is preferred in this connection if, as already mentioned, the clear coating compositions A and B contain the same photoinitiators, light stabilizers or UV absorbers.

Apart from photoinitiators, light stabilizers or UV absorbers, clear coating compositions A and B may contain further conventional coating additives. Examples of conventional coating additives are levelling agents, rheological agents, such as highly disperse silica or polymeric urea compounds, thickeners, for example based on partially crosslinked carboxy-functional polymers or on polyurethanes, defoamers, wetting agents, anticratering agents, catalysts, antioxidants. The additives are used in conventional amounts known to the person skilled in the art.

In the process according to the invention, process steps a) and b) proceed before process step c). Process steps a) and b) may proceed simultaneously or preferably successively in any desired order, wherein it is in particular preferred for process step a) to proceed before process step b).

In process step a), spray application onto at least portions of the precoated surface of the automotive bodies, which portions are not directly accessible to an external observer but are in principle accessible to spray coating, of a clear coat layer of a clear coating composition A curable by free-radical polymerization of olefinic double bonds on exposure to UV radiation proceeds in accordance with conventional methods known to the person skilled in the art. The phrase “at least portions of the precoated surface of the automotive bodies, which portions are not directly accessible to an external observer but are in principle accessible to spray coating” encompasses at least the zones which are not covered with trim on the finished motor vehicle of the surfaces belonging to the door entries which are coated with electrodeposition coating primer and base coat and optionally with interlayers. A clear coat of the clear coating composition A is preferably applied only onto the door entries or said zones of the door entries and on the surfaces of the passenger compartment which are not covered with trim in the finished motor vehicle, particularly preferably only onto the door entries or said zones of the door entries.

In process step b), spray application onto the outer surface, finished in color-determining manner, of the automotive bodies, which surface is directly accessible to an external observer and to spray coating, of a clear coating composition B curable by free-radical polymerization of olefinic double bonds on exposure to UV radiation likewise proceeds in accordance with conventional methods known to the person skilled in the art.

The process according to the invention is particularly preferably used on bodies which, as finished motor vehicles, have no surfaces in the passenger compartment which are not covered by trim. In this case, it is particularly preferred to coat only the door entries precoated in color-determining manner or zones of the door entries precoated in color-determining manner which are not covered with trim in the finished motor vehicle with clear coat A and the outer body skin precoated in color-determining manner with clear coat B.

Depending on the nature of liquid clear coating compositions A and B, a flash-off phase, which serves to remove volatile components such as solvents and/or water, is provided before the UV irradiation in the final process step c). Flashing-off is performed, for example, for 5 to 10 minutes at an air temperature of 20 to 80° C.

In the preferred case that powder clear coatings A and B are used in process steps a) and b), prior to UV irradiation in the final process step c), the powder clear coating layer is melted and caused to merge by exposure to heat, for example for 5 to 10 minutes at an object temperature of 80 to 150° C.

In process step c), the clear coat layer applied from clear coating compositions A and B is cured by UV irradiation and the consequently induced free-radical polymerization of olefinic double bonds and optionally additionally by supply of thermal energy in the event that clear coating compositions A and B are dual-cure clear coats.

UV irradiation of the bodies may proceed without special equipment to achieve purposeful UV irradiation of the surfaces coated with clear coat A. For example, purposeful UV irradiation of the outer body skin coated with clear coat B under conditions which allow UV radiation to gain access to the surfaces coated with clear coat A is sufficient. For example, in order to achieve UV irradiation of the surfaces which are coated with clear coating composition A and do not belong to the outer body skin, i.e. door entries and optionally further internal body surfaces, it is sufficient if the body doors are opened or open by an angle ranging from 10 degrees to an angle corresponding to complete opening before or during the purposeful UV irradiation of the outer body skin. Alternatively, although not preferably, the doors may be also be coated and UV-irradiated separately from the bodies before being fitted. While the outer body skin coated with clear coat B may in this manner purposefully be irradiated with UV radiation, the UV radiation or UV radiation dose which reaches the surface coated with clear coat A with the doors open is sufficient to achieve curing of clear coat A which proceeds at least to an extent such that adequate usability is achieved.

UV irradiation of the outer body skin coated with clear coat B may, for example, proceed in a belt unit fitted with one or more UV radiation emitters or the bodies and/or the UV radiation emitter(s) are moved relative to one another during irradiation. For example, the bodies may be moved through an irradiation tunnel fitted with one or more UV radiation emitters and/or a robot equipped with one or more UV radiation emitters may guide the UV radiation emitter(s) over the outer body skin.

If desired, UV irradiation of surfaces not belonging to the outer body skin and coated with clear coating composition A may be assisted, for example by using mirror systems to propagate diffuse UV light into the body interior or by using robots equipped with UV radiation sources in order purposefully to UV-irradiate the surfaces coated with clear coating composition A.

UV irradiation may proceed in one or more temporally and optionally spatially separate steps. UV irradiation may take place continuously or discontinuously (in cycles).

In principle, during UV irradiation of the outer body skin coated with clear coat B, the duration of irradiation, object distance and/or radiation output of the UV radiation emitter may be varied, so adjusting the radiation dose. A sufficiently high radiation dose is here vital to achieving sufficient curing by free-radical polymerization which ensures that technical requirements are met, such as hardness, resistance to chemicals and scratching or weathering resistance. Conventional UV-radiation doses for the outer body skin are in the range from for example 500 to 3000 mJ per square centimeter.

The preferred source of radiation comprises UV radiation sources emitting in the wave length range from 180 to 420 nm, in particular from 200 to 400 nm. Examples of such continuously operating UV radiation sources are optionally doped high, medium and low pressure mercury vapor emitters and gas discharge tubes, such as for example low pressure xenon lamps. Discontinuous UV radiation sources may, however, also be used. These are preferably so-called high-energy flash devices (UV flash lamps for short). The UV flash lamps may contain a plurality of flash tubes, for example, quartz tubes filled with inert gas such as xenon. The UV flash lamps have an illuminance of, for example, at least 10 megalux, preferably from 10 to 80 megalux per flash discharge. The energy per flash discharge may be, for example, 1 to 10 kJoule.

The irradiation time with UV radiation when UV flash lamps are used as the UV radiation source may be, for example, in the range from 1 millisecond to 400 seconds, preferably from 4 to 160 seconds, depending on the number of flash discharges selected. The flashes may be triggered, for example, about every 4 seconds. Curing may take place, for example, by means of 1 to 40 successive flash discharges.

If continuous UV radiation sources are used, the irradiation time may be, for example, in the range from a few seconds to about 5 minutes, preferably less than 5 minutes.

The distance between the UV radiation sources and the surface to be irradiated may be, for example 5 to 60 cm.

If dual-cure clear coats A and/or B have been used, thermal energy may be supplied in conventional manner, for example by convection and/or infrared irradiation, to cure the clear coat layer by means of additional thermal crosslinking mechanisms. The additional thermal curing may be performed before, during and/or after the UV irradiation.

The process according to the invention makes it possible to provide automotive bodies with a clear top coat layer of a clear coating curable by free-radical polymerization of olefinic double bonds on exposure to UV irradiation and to cure said clear top coat layer. Clear coat A need not here be a dual-cure clear coat. It is sufficient if both clear coats A and B are systems which are curable solely by free-radical polymerization of olefinic double bonds on exposure to UV radiation and which contain no thermally curable components or functional groups. In the process according to the invention, during UV irradiation in process step c), the clear coat layer applied from clear coat A generally receives lower radiation doses than the clear coat layer applied from clear coat B, for example down to as little as only 5 mJ per square centimeter, and may in individual cases be less fully cured and not achieve in all respects the technical level of the clear coat layer of clear coat B, but surfaces usable for practical purposes are nevertheless obtained. It must be borne in mind in this connection that much higher requirements are placed on the clear coat layer on the outer body skin than are placed on the clear coat layer on all other surface zones which, in service, are not exposed or not exposed to the same extent to the environmental and service conditions to which the outer body skin is exposed.

### EXAMPLE

Example (Simulation of the Process According to the Invention With Metal Test Panels Fastened to an Automotive Body):

a) Production of a Polyurethane Diacrylate:

547 pbw (parts by weight) of 1,6-hexane diisocyanate (HDI) were initially introduced into a 2 litre, four-necked flask equipped with a stirrer, thermometer and column and 0.1 pbw of methylhydroquinone and 0.1 pbw of dibutyltin dilaurate were added. The reaction mixture was heated to 60° C. 186.2 pbw of neopentyl glycol were then added in such a manner that the temperature did not exceed 80° C. The reaction, mixture was stirred at 80° C. until an NCO content of <16.8% was reached. Once the NCO content had been reached, the mixture was first cooled back down to 65° C. and then 188.9 pbw of hydroxyethyl acrylate were added in such a manner that a temperature 60 to 80° C. was maintained. The temperature was then maintained at 80° C. until an NCO content of <5.9% was reached. Once the NCO content had been reached, the mixture was heated to 90° C. 76.9 pbw of 1,6-hexanediol were then added in such a manner that a temperature of 85-100° C. was maintained. The reaction mixture was stirred at 100° C. until an NCO content of <0.1% had been reached. The hot melt was then discharged and allowed to cool.

b) Production of a Powder Clear Coating Composition A:

A comminuted mixture of the following components was premixed and extruded:
98.3 pbw of the polyurethane diacrylate from step a),
1.0 pbw of Irgacure® 2959 (photoinitiator from Ciba),
0.3 pbw of Powdermate® 486 CFL (levelling additive from Troy Chemical Company),
0.3 pbw of Tinuvin® 144 (HALS light stabilizer from Ciba) and
0.1 pbw of Tinuvin® 405 (UV absorber from Ciba)
to produce, after cooling, crushing, grinding and sieving, a powder clear coating composition A.
   c) Production of a Powder Clear Coating B:

A powder clear coating composition B of the following composition was produced in a similar manner:
96.7 pbw of the polyurethane diacrylate from step a), 1.0 pbw of Irgacure® 2959,
0.3 pbw of Powdermate® 486 CFL,
1.0 pbw of Tinuvin® 144 and
1.0 pbw of Tinuvin® 405.
   d) Application and Curing of Powder Clear Coatings A and B

Powder clear coating compositions A and B were each applied to a film thickness of 60 μm onto 5 cm×5 cm steel test panels which had been provided with a coating structure comprising electrodeposition coating, filler and water-borne base coat and fastened onto a test body. The metal panels coated with powder clear coating B were fastened onto the outside of the fitted driver's door, while the panels coated with powder clear coating A were fastened to the driver's door frame (facing the B-pillar) or on the door sill.

The test body was placed in a baking oven, where powder clear coatings A and B were exposed to an oven temperature of 140° C. for 10 minutes and melted. Curing was then performed by means of UV radiation, with the driver's door being opened to an opening angle of 45°. The body was passed before stationarily mounted UV radiation emitters (UV portal for curing vehicle bodies, adapted to the body outline) in such a manner that a radiation intensity for the outer body skin of at least 500 mW/cm2 and a radiation dose of at least 1500 mJ/cm2 was obtained at all points. In the interior zone of the driver's door or on the door sill, an intensity of 10-20 mW/cm2 at a dose of 50-150 mJ/cm2 was obtained.

Not only the optical properties, but also the hardness, solvent resistance and conversion of double bonds were identical for both powder clear coatings, these characteristics meeting the requirements placed on an automotive clear coat layer.

1. A process for the production of a clear top coat layer on automotive bodies, characterized in that application of the clear coat comprises the following steps:
a) spray application onto at least portions of the precoated surface of the automotive bodies, which portions are not directly accessible to an external observer but are in principle accessible to spray coating, of a clear coat layer from a clear coating composition A curable by free-radical polymerization of olefinic double bonds on exposure to UV radiation,
b) spray application onto the outer surface, finished in color-determining manner, of the automotive bodies, which surface is directly accessible to an external observer and to spray coating, of a clear coat layer from a clear coating composition B curable by free-radical polymerization of olefinic double bonds on exposure to UV radiation, and
c) curing of the clear coat layer applied from clear coating compositions A and B in process steps a) and b) by means of UV radiation-induced, free-radical polymerization of olefinic double bonds, wherein the clear coating compositions A and B, in each case relative to the resin solids content thereof, differ from one another (1) by clear coating composition A having a higher content of photoinitiator(s) or (2) by clear coating composition A having a lower content of light stabilizer(s) and/or UV absorber(s) or (3) by clear coating composition A having a lower content of light stabilizer(s) and/or UV absorber(s) with clear coating compositions A and B at the same time having a different content of photoinitiator(s).

2. The process of claim 1, wherein the two clear coating compositions A and B are liquid, solvent- and/or water-containing clear coating compositions, liquid, solvent- and water-free clear coating compositions or powder clear coating compositions.

3. The process of claim 1, wherein the clear coating compositions A and B, in each case relative to the resin solids content thereof, differ from one another (1) only by clear coating composition A having a higher content of photoinitiator(s) or (2) only by clear coating composition A having a lower content of light stabilizer(s) and/or UV absorber(s) or (3) only by clear coating composition A having a lower content of light stabilizer(s) and/or UV absorber(s) with clear coating compositions A and B at the same time having a different content of photoinitiator(s).

4. The process of claim 1, wherein, with regard to photoinitiators, light stabilizers and UV absorbers, clear coating compositions A and B contain the same compounds.

5. The process of claim 1, wherein process steps a) and b) proceed simultaneously or successively in any desired order.

6. The process of claim 1, wherein process step a) proceeds before process step b).

7. The process of claim 1, wherein the surfaces coated with the clear coating composition A in process step a) are the surfaces belonging to the door entries or the zones of the surfaces belonging to the door entries which are not covered with trim in the finished motor vehicle.

8. The process of claim 1, wherein, during UV irradiation of the outer body skin, the body doors are opened or open by an angle ranging from 10 degrees to an angle corresponding to complete opening.

9. Automotive bodies provided with a clear coating layer using the process of claim 1.
